(19) United States
(12) Patent Application Publication
(10) Pub. No.: US 2002/0110685 A1
(43) Pub. Date: Aug. 15, 2002

(54) Tie layers for PVA coatings

(76) Inventors: Ikuko Ebihara, St. Paul, MN (US); Guy M. Kallman, Woodbury, MN (US); Gregory E. Gilligan, Hastings, MN (US); William L. Kausch, Cottage Grove, MN (US); Brian H. Williams, White Bear Lake, MN (US); Robert W. Horn, Woodbury, MN (US)

Correspondence Address: Attention: William D. Miller, Office of Intellectual Property Counsel, 3M Innovative Properties Company, P.O. Box 33427, St. Paul, MN, 55133-3427, US

(21) Appl. No.: 09/781,534

(22) Filed: Feb. 9, 2001

(51) Int. Cl. B32B 27/36

(52) U.S. Cl. 428/336; 428/483; 428/910; 264/204

(57) ABSTRACT

A tie layer film, comprising an admixture of polyvinyl alcohol and a water dispersible polyester, for bonding a support film to a topcoat layer. The preferred tie layer comprises a sulfopolyester, preferably including terephthalate groups or isophthalate groups. Most preferred are sulfopolyesters produced from ingredients comprising monomers selected from the group consisting of dimethyl 5-sodiosulfoisophthalate, dimethyl terephthalate, dimethyl isophthalate, ethylene glycol, and polycaprolactone diol. Alternatively the support film may be a layered film. In a preferred embodiment, the topcoat layer is formed from the same PVA material as the tie layer and the support film includes at least a portion of the same sulfopolyester as the tie layer. The tie layer is capable of maintaining the bond between the support film and the topcoat layer when heat stretched to a stretch ratio in the range of 2 times to 10 times its original dimension.

### FIELD OF THE INVENTION

The present invention relates to film products comprising supported and oriented polyvinyl alcohol (PVA) layers and the processes for making them. More particularly the invention relates to a tie layer for adhering polymer layers such as polyvinyl alcohol to other polymeric films, particularly polyester films such as polyethylene terephthalate, polyethylene naphthalate and other polyesters and copolymers thereof, particularly when the polymers undergo stretching at elevated temperatures.

### BACKGROUND OF THE INVENTION

Oriented polyvinyl alcohol (PVA) films are used in the production of optical dichroic polarizers. Dichroic polarizers absorb light of one polarization and transmit light of the other polarization. One typical commercial example of a dichroic polarizer is PVA that has been stained with iodine. Polarizers using other dichroic dyes such as anthraquinone and azo dyes, and using other polymers are also known.

Another type of polarizer is a reflective polarizer, typically made by forming a stack of alternating sets of polymer layers, one of the sets being birefringent to form reflective interfaces in the stack. These polarizers typically reflect light having one polarization and transmit light having an orthogonal polarization.

Early work in light polarizers is disclosed in Hooper et al. U.S. Pat. No. 4,388,375, which teaches stretching PVA films and then laminating on a substrate under pressure and by using an adhesive such as water, polyvinyl alcohol or polyurethane. Related Rogers et al. U.S. Pat. No. 4,659,523 also discloses PVA applied as a film to polyethylene terephthalate along with what is termed an anchor coating. Polyester anchors are preferred.

The combination of a dichroic polarizer and a multilayer optical film is also known. Commonly owned Merrill et al. U.S. Pat. No. 6,111,697 and Kausch et al. U.S. Pat. No. 6,113,811 both disclose optical devices which include a dichroic polarizer and multilayer polymer film formed using polyester materials. The polarizers can be used with other films such as multilayer optical films and the like.

Commonly owned Ouderkirk et al U.S. Pat. No. 6,096,375 describes an optical polarizer using a reflective polarizer and a dichroic polarizer in combination, in which the two polarizers are preferably bonded together to eliminate the air gap between the polarizers.

What has not been recognized in the art is the need to attach PVA layers to polyester substrates in a way that allows the combination to be stretched to stretch ratios of 6.0 or more while preserving the bond, so that the PVA adheres adequately, after exposure to aqueous solutions, to produce economically useful quantities in the manufacturing process.

Accordingly it would be of great advantage in the art if a tie layer could be produced with sufficient strength to maintain adhesion between an unstretched cast polyester film and a PVA layer during a heat stretch process and, also, during a staining process involving exposure of the PVA layer to aqueous solutions such as those containing KI, I, or boric acid.

It would be another advance in the art if the tie layer could be made easily and with presently available materials, and would not adversely affect the optical properties of the final product. Other advantages will appear hereinafter.

### SUMMARY OF THE INVENTION

The present invention provides a tie layer film for bonding PVA layers to heat stretchable support films such as polyesters and copolyesters. PVA layers of this type are useful in dichroic polarizers and other optical devices. The tie layers of the present invention reduce the tendency of PVA layers to shrink, lose adhesion, or otherwise fail when subjected to aqueous solutions such as iodine staining baths and boric acid fixing baths, especially after the PVA layers have been subjected to high levels of heat stretching.

The tie layers of the present invention comprise blends of PVA and water dispersible polymers which can be applied as aqueous coatings but which exhibit significant water resistance when dried. Particularly useful water dispersible polymers include sulfopolyesters and copolymers thereof.

The present invention also provides a film product suitable for staining with iodine or orientable dye to form an optical polarizer. The film product comprises a heat stretchable support film, a tie layer attached thereto, and a PVA layer attached to the tie layer, wherein the PVA layer has been oriented by heating and stretching the film in a preferred direction.

### BRIEF DESCRIPTION OF THE DRAWINGS

For a more complete understanding of the invention, reference is hereby made to the drawings, in which:

FIG. 1 is a side elevational view of one embodiment of a film product according to the present invention;

FIG. 2 is a side elevational view of one embodiment of a multilayer optical film for use in the optical polarizer of FIG. 1; and

FIG. 3 is a side elevational view of another embodiment of a multilayer optical film for use in the optical polarizer of FIG. 1.

### DETAILED DESCRIPTION OF THE PREFERRED EMBODIMENT

As used herein, the term water dispersible means that a material can be dissolved in water or aqueous based liquids, or that it can form colloidal dispersions in water or aqueous based liquids. A colloidal dispersion is taken to mean that the dispersed material is in the form of small particles having the largest dimension in the range of 0 to 10 microns. Typically, the particle size in colloidal dispersions is in the range below 1 micron.

As used herein, the term water resistant water dispersible means that a material is not readily soluble in water or aqueous based solvent, but may be dispersed in water if additional steps are taken. An example of such additional steps might be to dissolve the material in a volatile organic solvent, add water to the resulting solution, and then drive off the volatile organic solvent by heating. Similarly, the term resistant to ionic aqueous solvents means that the material is not readily soluble in aqueous ionic solvents, but may be dispersed in them by, for example, first dissolving in a volatile organic solvent, adding water and some ionic species, if not already present, and then removing the organic solvent by heating. Water and/or ionic aqueous solvent resistant factors may have to be considered when staining with a solution of potassium iodide or iodine.

As used herein, the terms sulfopolymer and sulfonated polymer mean a polymer comprising at least one unit containing a salt of the—SO₃H group, preferably an alkali metal or ammonium salt.

As used herein, the term machine direction (MD) means the direction of transport of the film product when it is formed as a continuous web by, for example, extrusion of the substrate and coating of the tie layer and topcoat layer. The term transverse direction (TD) means the direction transverse to the MD, in the plane of the web.

As used herein, the term coating fluid means a liquid medium containing the material to be coated in a form that enables a layer to be coated onto a substrate and dried to form a substantially continuous solid layer. Examples of coating fluids include, but are not limited to, solutions, colloidal dispersions, and solutions also containing colloidal dispersions.

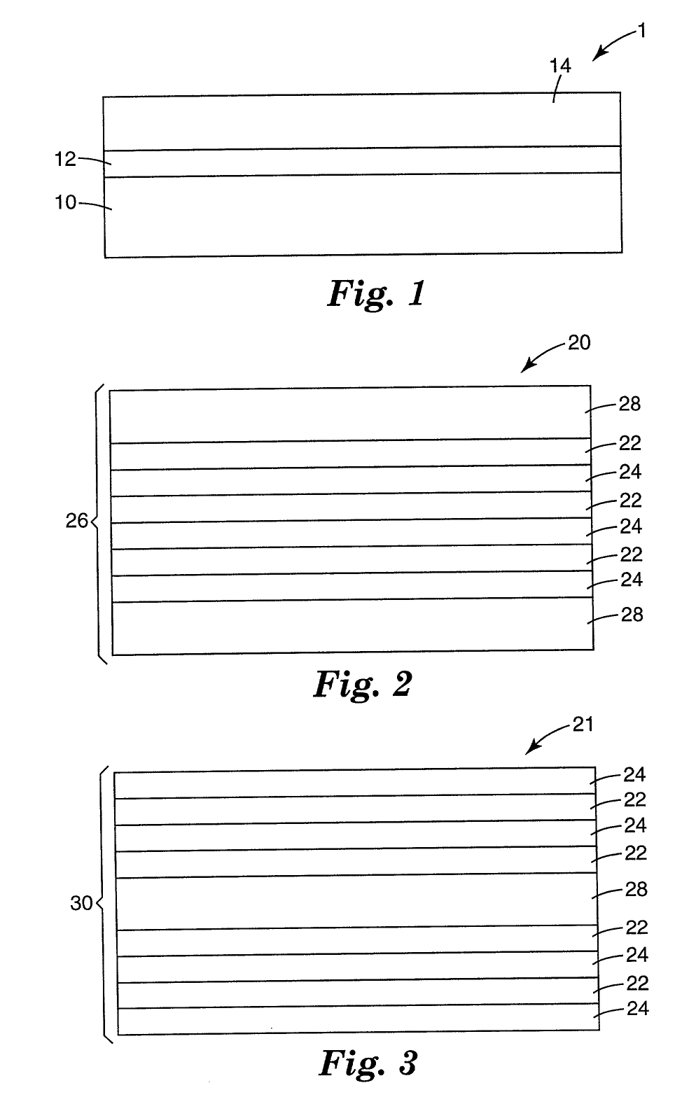

As shown in FIG. 1, the present invention is shown, wherein tie layer 12 forms an intermediate layer between film support 10 and PVA layer 14. The tie layer 12 of the present invention comprises a water dispersible but water resistant blend of a sulfonated polyester and PVA. Suitable sulfonated polyesters include WB-54, prepared as set forth in U.S. Pat. No. 5,203,884, Example 6 and designated therein as polymer B dispersion. Examples of these sulfonated polyesters are set forth in commonly owned U.S. Pat. No. 5,203,884, and is incorporated herein by reference as an example of the sulfonated polyesters of this invention. Suitable examples of PVA are Airvol 425 PVA, manufactured by Air Products and Chemicals, and Kuraray PVA-117H polyvinyl alcohol, manufactured by Kuraray Co., Ltd. Other PVA's which are generally characterized by a degree of polymerization of 1000 or greater and a level of hydrolysis of 95% or higher are also suitable. It is preferred that the PVA used herein has a degree of polymerization of at least 1000, and has a degree of hydrolysis in the range of 96% to 99.9%.

Multilayer optical films of the type portrayed in FIGS. 2 and 3 and disclosed in commonly owned U.S. Pat. No. 6,113,811, incorporated herein by reference, may be used as the film support in the present invention. Referring to FIG. 2, alternating optical layers 22 and 24 can have differing optical properties such as differing refractive indices and differing levels of birefringence, which, depending upon specific properties, may produced a variety of optical effects, including reflective effects and polarization effects. Layers 28 may serve to provide desirable surface properties such as damage protection or adhesion, as well as improved overall mechanical properties such as stiffness. Layers 28 may also be chosen to provide improved extrudability. Referring to FIG. 3, it may in some cases be useful to place layer 28 between groups of alternating layers 22 and 24. While the multilayer feature of support films can provide useful optical effects, it will be appreciated that multilayer films which do not provide such special optical effects may also be used in particular embodiments of the present invention.

The tie layer may have a concentration of total solids, before coating and drying of from about 2% to 15% by weight, and preferably from 4% to 6%. The weight ratio of sulfonated polyester to PVA to may range from 90:10 to 10:90, and preferably from about 80:20 to 20:80.

The preferred stretching operation is conducted by transporting the film to a tentering apparatus which stretches the dried film in a direction transverse to the direction of film transport. Dry adhesion in this process is accomplished via the tie layer of the present invention, permitting stretch ratios greater than previously possible.

Film support 10 can be any substrate to which tie layer 12 will adhere. In applications where film product 1 is an optical device such as a polarizer, it is preferred that support film 10 be transparent to visible light and heat stretchable in a preferred direction, portrayed in FIG. 1 as direction 16. Support film materials which have been found particularly useful include polyethylene terephthalate (PET), polyethylene naphthalate (PEN), and copolymers thereof, though other polymers may also be found to be useful.

Support film 10 may be a single layer of material, or may be multilayered. Multilayer films may, for example, be made up of a center or core layer, and two outer or skin layers. The core layer may be chosen for superior mechanical properties, temperature stability, or other useful core properties, and the skin layers may be chosen for adhesion, abrasion resistance, or other desirable properties. In some instances, it may be useful for support film 10 to exhibit strain leveling at elevated temperatures. Strain leveling means that as the film is stretched at elevated temperatures, the caliper of the film becomes more uniform. Since materials which exhibit good strain leveling may not exhibit good adhesion, it may be useful to use skin layers to provide the needed adhesive properties. It is also useful for the adhesion between any layers of multilayer films be suitably robust, since if this interlayer adhesion is less than the adhesion of the PVA layer to the film support, the usefulness of the tie layer will be limited.

Another type of useful multilayer film is a film made up of a large number of alternating polymeric layers which, together, produce useful optical effects such as reflective optical polarization. Films of this sort are disclosed in commonly owned U.S. Pat. No. 5,612,820, incorporated herein by reference. Use of multilayer polarizing films in combination with oriented PVA layers can provide more efficient utilization of available light, due to the multilayer films being reflective polarizers, thereby allowing reflected light to be utilized, perhaps by polarization rotation or other light recycling means. In applications of this sort, the PVA layer can be stained with iodine or a polarizing dye, for example, to provide an absorbing, or cleanup, polarizer which improves the polarization quality of the transmitted light.

It may also be useful to apply an adhesion promoting treatment to surface 11 of support film 10. One such treatment which has been found useful is a corona treatment.

In the preferred embodiment, a support film of, for example, a thermoplastic polyester, is formed by first extruding a molten polymer composition, which may be made up of more than one layer of different polymer compositions as shown above, onto a casting roll and cooling it to form a continuous support film. Polymers and copolymers containing polyethylene terephthalate, polyethylene naphthalate, along with other chemical groups have been found suitable for use as support films. The various patents cited and incorporated herein by reference list other suitable polymers and copolymers that form the support film. Single and multiple layer films, depending upon desired film properties and performance for specific applications will be selected in accordance with practices in the industry by those skilled in the art.

After cooling, the support film is transported past a tie layer coating head, and is coated with a tie layer in accordance with this invention. One example of a tie layer coating head is an extrusion bar coating head, although any coating apparatus suitable for applying water dispersed coatings is contemplated. After application of the tie layer coating, it is dried, for example by passing the coated support film through a suitable oven. Next, a second coating head is used to apply a coating such as a water dispersion of PVA, after which the coated layer is again dried. Solvents other than water may be used, provided safety considerations are observed. Optionally the support film may be transported past a corona treating head prior to coating the tie layer.

After drying, the coated film passes into an oven where it is heated and stretched, at a stretch ratio of 5.0, or 6.0, or greater, depending on the specific films being employed. A preferred stretch ratio ranges from 2 to 10 times the original dimenstion of the film product. More preferred is a stretch ratio in the range of 6.5 times its original dimension to 7.0 times its original dimension. Stretching is conveniently done by stretching in the direction transverse to the direction of film transport by means of a tentering apparatus as previously described. The stretch ratio is measured by printing a grid of known dimensions on the unstretched film, measuring the grid dimensions after stretching, and calculating the stretch ratio as (dimension after stretching)/(original dimension).

The tie layer of the present invention provides surprisingly effective dry adhesion. When the PVA layer of the present invention is subjected to iodine staining or other processes to adjust the optical properties of the PVA, wet adhesion of the PVA to the reflective polarizer is sufficient, when using the tie layer of this invention.

### EXAMPLES

It has been found that PVA coatings have limited adhesion to polyesters, multilayer optical films and the like when subjected to stretching at the temperatures necessary to obtain the optical properties desired and needed for industrial applications. A number of examples are presented below to demonstrate the efficacy of this invention in accomplishing that bonding during optical processing.

In some instances in these experiments, it has been found that dispersion of some of the components in deionized water may require some heating of the water to provide an adequate dispersion. One skilled in the art will be able to judge the necessity and amount of such heating, recognizing the need for uniform dispersion of materials, particularly when used in optical end uses. The examples presume an adequate dispersion and the use of heat for that purpose is not specifically noted in the following examples.

The materials used in these examples are commercially available. As noted above, Airvol PVA is manufactured by Air Products and Chemicals, and Kuraray PVA-117H polyvinyl alcohol is manufactured by Kuraray Co., Ltd. The sulfonated polyester used in these examples is WB-54, prepared as set forth in U.S. Pat. No. 5,203,884, Example 6 and designated therein as polymer B dispersion.

The test method for measurement of PVA adhesion on films measures the delamination of PVA coatings by delamination at 90° peels and calculating the five second average adhesion. Results are reported in grams per inch. A reasonable estimate of sample variability has been calculated to be ±10%, relative to the true mean value. A Slip Peel tester having a 90° test jig is used to measure the delamination force.

The first step requires preconditioning of samples. Samples of sufficient size to provide a representative sampling of the coated product, and to provide sufficient material for several peel test samples, were cut from the coated web. The direction of transport during coating, MD, was either noted on the samples or was apparent from the shape of the cut samples. Before testing, the samples were preconditioned by first placing them in an aqueous iodine preconditioning solution having a temperature of 30° C. for 24 seconds, followed by placing them in a boric acid curing solution at 65° C. for 24 seconds, with a final rinse in deionized water at 30° C. for 24 seconds. The samples were then dried with 60° C. air for 30 seconds. The iodine preconditioning solution was made up of 0.15% by weight of iodine, 21% by weight of potassium iodide, and 78.85% by weight of deionized water. The boric acid solution was made up of 14.5% by weight of boric acid, 4.5% of borax, and 81% by weight of deionized water.

Peel test samples having a width of 25.4 mm (1 inch) were cut from the preconditioned test samples to form test strips running in the machine direction of the samples, with the 25.4 mm dimension being transverse to the machine direction. The length of the test strips was approximately the length of the glass test plate to which there were to be mounted. Each sample was laminated over its full length and width to the glass plate, with the coated side to be tested facing away from the glass, using a strip of double stick adhesive tape having a high adhesive strength, such as Scotch Brand #665 double coated tape having a width of 25.4 mm, available from 3M Company, St. Paul, Minn. A 25.4 mm wide strip of Scotch Brand #665 tape was then applied to the sample in a direction parallel to the long dimension of the sample, so as to cover substantially all of the test sample, but leaving about a 25 mm extra length of tape to use as a pull-tab during testing. After allowing the tape sample to set for about 20 seconds at room temperature, the 90° peel test was performed.

The 90° peel test was initiated by holding the pull-tab at an angle of about 90° to the glass plate and giving a quick, short pull or snap to the tape tab to initiate the peel. The sample was then placed in a recording peel tester set to pull the tape at a direction of 90° to the sample plate. The peel tester was started and peel force was recorded. The peel strength was the average over a 5 second time interval. Five samples were tested in this manner, with the reported peel strength being the average of the peel strength for the five samples. A final check of the peeled sample was made to determine the interface at which the peel actually took place.

Wet adhesion, or edge pull-back, is measured by cutting out a sample of the coated film having known dimensions, immersing the sample in a solution of 4% by weight of boric acid at 65° C. for two minutes. Adhesion is measured as millimeters of edge pull-back, which is the distance which the PVA coating shrinks relative to the support film edge pull-back is measured as the maximum distance between the edge of the coating and the edge of the support film. Usually the maximum edge pull-back will occur in the direction in which the coated film was stretched. Edge pull-back can be expressed either in millimeters or as a percentage of the distance from the center of the sample the edge from which maximum pull-back occurs. Wet adhesion is relevant, as has been stated herein, during iodine staining.

### Example 1

A tie layer coating fluid premix was prepared by first dissolving a predetermined quantity of Airvol 425 PVA in a predetermined quantity of deionized water and heated, followed by the addition of a predetermined quantity of WB-54 aqueous dispersion to produce a coating fluid, hereinafter designated Coating Dispersion I, having a total solids content of 10%, with the weight ratio of WB-54 to Airvol 425 being 7:3. All of the dispersions were formed using an air driven propeller mixer, used in a conventional manner.

### Example 2

A PVA coating dispersion, designated coating dispersion PVA 425-1, was prepared by mixing one part by weight of dry Airvol 425 PVA flakes in 8.8 parts by weight of deionized water to form a dispersion. Mixing was accomplished using an air-driven propeller mixer. In order to obtain a clear solution of the dispersion, the deionized water was heated during mixing.

### Example 3

A PVA layer was formed as a continuous coating on a multilayer optical film substrate by first casting and then orienting a multilayer optical film made up of alternating layers of polyethylene naphthalate and a copolyester. The copolyester layers comprised naphthalene dicarboxylate and dimethylene terephthalate repeat units, present in a ratio of 55:45, on a molar basis, and diol-derived repeat units of ethylene glycol and hexanediol, wherein the hexanediol made up 5 mole percent of the diol-derived portion of the copolyester.

The cast web was then transported past a corona treater and then past a first coating head where the tie layer coating fluid dispersion I of Example 1, above, was deposited to a thickness sufficient to produce a fluid layer of 7.6 microns, prior to drying the coated layer. The tie layer coating was dried by passing the coated web through an oven at a temperature of about 70 to 120 ° C.

The web was then transported past a second coating head which applied a layer of PVA-425-1, as prepared in Example 2 to produce a fluid topcoat layer. The resulting coated web was dried by a second oven at a temperature of about 70 to 120 ° C. to produce a solid topcoat layer. The resulting coated web was then transported to a tentering oven where it was heated to a temperature of 156 ° C. and stretched in a direction transverse to the direction of web transport to a stretch ratio of about 6.8 times its original dimension, thereby reducing the thickness of the topcoat layer from its original dried thickness to about 1.3 microns. The dried web was then gradually cooled through additional stages of the oven, finally reaching room temperature.

Dry adhesion of the PVA layer to the multilayer optical support layer was measured using a 90 ° Peel Test, producing an adhesion of 20.7 grams/mm or 526 grams per inch, as averaged over five samples.

### Example 4

A tie layer coating dispersion was prepared by adding 1.025 parts of aqueous WB-54 sulfonated polyester dispersion, containing approximately 20 parts by weight of the sulfonated polyester, to 5.109 parts of deionized water, to which mixture was added 10.866 parts of aqueous Kuraray PVA-117H, containing 7.5 parts by weight of the PVA resin dissolved in 92.5 parts by weight of deionized water, then stirring the mixture at room temperature with an air driven propeller mixer until a uniformly mixed dispersion was obtained. This is designated tie layer Dispersion II.

### Example 5

A PVA coating dispersion was prepared by adding 7.5 parts by weight of Kuraray PVA-117H to 92.5 parts by weight of deionized water. This mixture was heated and stirred with an air driven propeller mixer until a clear dispersion was obtained. This dispersion is designated PVA-117H.

### Example 6

A supported and oriented PVA layer was formed as a continuous web on a multilayer optical film substrate by first casting a multilayer optical film of the configuration of Example 3 onto a casting roll and cooling. The resulting cast web was then transported past a corona treater and then past a first coating head where the tie layer coating dispersion II prepared in Example 4 was deposited at a thickness sufficient to produce a coated layer having a wet thickness of 55.7 microns (2.2 mils). The tie layer coating was dried by passing the coated web through an oven at a temperature of about 70 to 120 ° C. The web was then transported past a second coating head which applied a layer of the coating dispersion PVA-117H prepared in Example 5 to produce a solid layer. The resulting coated web was dried by a second oven at a temperature of about 70 to 120 ° C. This coated web was then transported to a tentering oven where it was heated to a temperature of 156 ° C. and stretched in a direction transverse to the direction of web transport to accomplish a stretch ration of about 6.8 times its original width, thereby reducing the thickness of the topcoat layer to about 1.3 microns. The web was then gradually cooled through additional stages of the oven to room temperature.

Both dry adhesion and wet adhesion were tested. The 90° Peel Test did not yield any peel, and the wet adhesion test yielded a coating pullback of less than 1 mm, which amounted to less that 2% of the possible pull-back distance. This was considered to be a sufficiently low level of pull-back for commercial processes using this invention.

It is preferred that the tie layer has a dried thickness in the range of 0.05 microns to 5.0 microns, and more particularly a dried thickness in the range of 1.0 microns to 5.0 microns.

The topcoat preferably has a dried thickness in the range of 0.5 microns to 35.0 microns, and more preferably a thickness in the range of 5.0 to 15.0 microns.

The tie layer preferably has a thickness of 0.01 to 0.7 microns after stretching, and more preferably of 0.15 to 0.4 microns after stretching.

The topcoat layer preferably has a thickness of 0.1 to 5.0 microns after stretching, and more preferably a thickness of 0.7 to 2.2 microns after stretching.

While particular embodiments of the present invention have been illustrated and described, it is not intended to limit the invention, except as defined by the following claims.

1. A coated film product formed by a process comprising the steps of:
a) providing an aqueous tie layer coating fluid, wherein said coating fluid comprises a polyvinyl alcohol and a water dispersible polyester;
b) applying said coating fluid to a support film to form a fluid layer on said support film;
c) drying said fluid layer to form a solid tie layer;
d) providing an aqueous topcoat coating fluid comprising polyvinyl alcohol;
e) applying said topcoat coating fluid to said tie layer to form a fluid layer; and
f) drying said polyvinyl alcohol fluid layer to form a solid topcoat layer.

2. The film product of claim 1, wherein said support film is a heat stretchable thermoplastic film.

3. The film product of claim 2, wherein the formation of said film product includes the further step of heating said film product and stretching it in a preferential direction.

4. The film product of claim 1, wherein said support film comprises at least two layers of different polymeric materials.

5. The film product of claim 1, wherein said support film comprises at least three layers of polymeric materials, wherein the materials that comprise each layer differ from the polymeric materials comprising adjacent layers.

6. The film product of claim 3, wherein said stretching elongates said film product to a stretch ratio in the range of 2 times its original dimension to 10 times its original dimension.

7. The film product of claim 3, wherein said stretching elongates said film product to a stretch ratio in the range of 6.5 times its original dimension to 7.0 times its original dimension.

8. The film product of claim 1, wherein said water dispersible polyester is a sulfopolyester.

9. The film product of claim 1, wherein said water dispersible polyester is a water resistant polyester.

10. The film product of claim 1, wherein said water dispersible polyester is a resistant to aqueous ionic solvents.

11. The film product of claim 8, wherein sulfopolyester includes terephthalate groups.

12. The film product of claim 8, wherein said sulfopolyester includes isophthalate groups.

13. The film product of claim 8 wherein said sulfopolyester is produced from ingredients comprising monomers selected from the group consisting of dimethly 5-sodiosulfoisophthalate, dimethyl terephthalate, dimethyl isophthalate, ethylene glycol, and polycaprolactone diol.

14. The film product of claim 1, wherein said polyvinyl alcohol has a degree of polymerization of at least 1000.

15. The film product of claim 1, wherein said polyvinyl alcohol has a degree of hydrolysis in the range of 96% to 99.9%.

16. The film product of claim 1, wherein said tie layer has a dried thickness in the range of 0.05 microns to 5.0 microns.

17. The film product of claim 1, wherein said tie layer has a dried thickness in the range of 1.0 microns to 5.0 microns.

18. The film product of claim 1, wherein said topcoat has a dried thickness in the range of 0.5 microns to 35.0 microns.

19. The film product of claim 1, wherein said dried topcoat has a thickness in the range of 5.0 to 15.0 microns.

20. The film product of claim 3, wherein said tie layer has a thickness of 0.01 to 0.7 microns after stretching.

21. The film product of claim 3, wherein said tie layer has a thickness of 0.15 to 0.4 microns after stretching.

22. The film product of claim 3, wherein said topcoat layer has a thickness of 0.1 to 5.0 microns after stretching.

23. The film product of claim 3, wherein said topcoat layer has a thickness of 0.7 to 2.2 microns after stretching.

24. The film product of claim 1, wherein the weight ratio of said polyester to said polyvinyl alcohol in said tie layer coating fluid is in the range of 90:10 to 10:90.

25. The film product of claim 1, wherein the weight ratio of said polyester to said polyvinyl alcohol in said tie layer coating fluid is in the range of 80:20 to 20:80.

26. The film product of claim 1, wherein the solids content of said tie layer is in the range of 2% to 15% solids.

27. The film product of claim 1, wherein the solids content of said tie layer coating fluid is in the range of 4% to 6% solids.

28. The film product of claim 1, wherein the solids content of said topcoat coating fluid is in the range of 5.0% to 15%.

29. The film product of claim 1, wherein the solids content of said topcoat coating fluid is in the range of 6% to 8%.

30. The film product of claim 1, wherein said support film produces a reflective polarizing effect.

31. A method of forming a film product, comprising the steps of:
a) providing an aqueous tie layer coating fluid, wherein said coating fluid comprises a polyvinyl alcohol and a water dispersible polyester;
b) applying said coating fluid to a support film to form a fluid layer on said support film;
c) drying said fluid layer to form a solid tie layer;
d) providing an aqueous topcoat coating fluid comprising polyvinyl alcohol;
e) applying said topcoat coating fluid to said tie layer to form a fluid layer; and
f) drying said polyvinyl alcohol fluid layer to form a solid topcoat layer.

32. The method of claim 31, wherein said support film is a heat stretchable thermoplastic film.

33. The method of claim 32, wherein the formation of said method includes the further step of heating said method and stretching it in a preferential direction.

34. The method of claim 31, wherein said support film comprises at least two layers of different polymeric materials.

35. The method of claim 31, wherein said support film comprises at least three layers of polymeric materials, wherein each layer differs from the polymeric materials comprising adjacent layers.

36. The method of claim 31, wherein said stretching elongates said method to a stretch ratio in the range of 2 times its original dimension to 10 times its original dimension.

37. The method of claim 33, wherein said stretching elongates said method to a stretch ratio in the range of 6.5 times its original dimension to 7.0 times its original dimension.

38. The method of claim 31, wherein said water dispersible polyester is a sulfopolyester.

39. The method of claim 31, wherein said water dispersible polyester is a water resistant polyester.

40. The method of claim 31, wherein said water dispersible polyester is a resistant to aqueous ionic solvents.

41. The method of claim 38, wherein sulfopolyester includes terephthalate groups.

42. The method of claim 38, wherein said sulfopolyester includes isophthalate groups.

43. The method of claim 38 wherein said sulfopolyester is produced from ingredients comprising monomers selected from the group consisting of dimethly 5-sodiosulfoisophthalate, dimethyl terephthalate, dimethyl isophthalate, ethylene glycol, and polycaprolactone diol.

44. The method of claim 31, wherein said polyvinyl alcohol has a degree of polymerization of at least 1000.

45. The method of claim 31, wherein said polyvinyl alcohol has a degree of hydrolysis in the range of 96% to 99.9%.

46. The method of claim 31, wherein said tie layer has a dried thickness in the range of 0.05 microns to 5.0 microns.

47. The method of claim 31, wherein said tie layer has a dried thickness in the range of 1.0 microns to 5.0 microns.

48. The method of claim 31, wherein said topcoat has a dried thickness in the range of 0.5 microns to 35.0 microns.

49. The method of claim 31, wherein said dried topcoat has a thickness in the range of 5.0 to 15.0 microns.

50. The method of claim 31, wherein said tie layer has a thickness of 0.01 to 0.7 microns after stretching.

51. The method of claim 33, wherein said tie layer has a thickness of 0.15 to 0.4 microns after stretching.

52. The method of claim 33, wherein said topcoat layer has a thickness of 0.1 to 5.0 microns after stretching.

53. The method of claim 33, wherein said topcoat layer has a thickness of 0.7 to 2.2 microns after stretching.

54. The method of claim 31, wherein the weight ratio of said polyester to said polyvinyl alcohol in said tie layer coating fluid is in the range of 90:10 to 10:90.

55. The method of claim 31, wherein the weight ratio of said polyester to said polyvinyl alcohol in said tie layer coating fluid is in the range of 80:20 to 20:80.

56. The method of claim 31, wherein the solids content of said tie layer is in the range of 2% to 15% solids.

57. The method of claim 31, wherein the solids content of said tie layer coating fluid is in the range of 4% to 6% solids.

58. The method of claim 31, wherein the solids content of said topcoat coating fluid is in the range of 5.0% to 15%.

59. The method of claim 31, wherein the solids content of said topcoat coating fluid is in the range of 6% to 8%.

60. The method of claim 31, wherein said support film produces a reflective polarizing effect.

61. A film product comprising:
a tie layer of an admixture of polyvinyl alcohol and a water dispersible polyester bonding a support film to a topcoat.

62. The film product of claim 61, wherein said support film is a heat stretchable thermoplastic film.

63. The film product of claim 62, wherein said film is stretched in a preferential direction at elevated temperature.

64. The film product of claim 61, wherein said support film comprises at least two layers of different polymeric materials.

65. The film product of claim 61, wherein said support film comprises at least three layers of polymeric materials, wherein each layer differs from the polymeric materials comprising adjacent layers.

66. The film product of claim 63, wherein said film product is stretched from 2 times its original dimension to 10 times its original dimension.

67. The film product of claim 63, wherein said film product is stretched from 6.5 times its original dimension to 7.0 times its original dimension.

68. The film product of claim 61, wherein said water dispersible polyester is a sulfopolyester.

69. The film product of claim 61, wherein said water dispersible polyester is a water resistant polyester.

70. The film product of claim 61, wherein said water dispersible polyester is a resistant to aqueous ionic solvents.

71. The film product of claim 68, wherein sulfopolyester includes terephthalate groups.

72. The film product of claim 68, wherein said sulfopolyester includes isophthalate groups.

73. The film product of claim 68, wherein said sulfopolyester is produced from ingredients comprising monomers selected from the group consisting of dimethly 5-sodiosulfoisophthalate, dimethyl terephthalate, dimethyl isophthalate, ethylene glycol, and polycaprolactone diol.

74. The film product of claim 61, wherein said polyvinyl alcohol has a degree of polymerization of at least 1000.

75. The film product of claim 61, wherein said polyvinyl alcohol has a degree of hydrolysis in the range of 96% to 99.9%.

76. The film product of claim 61, wherein said tie layer has a dried thickness in the range of 0.05 microns to 5.0 microns.

77. The film product of claim 61, wherein said tie layer has a dried thickness in the range of 1.0 microns to 5.0 microns.

78. The film product of claim 61, wherein said topcoat has a dried thickness in the range of 0.5 microns to 35.0 microns.

79. The film product of claim 61, wherein said dried topcoat has a thickness in the range of 5.0 to 15.0 microns.

80. The film product of claim 63, wherein said tie layer has a thickness of 0.01 to 0.7 microns after stretching.

81. The film product of claim 63, wherein said tie layer has a thickness of 0.15 to 0.4 microns after stretching.

82. The film product of claim 63, wherein said topcoat layer has a thickness of 0.1 to 5.0 microns after stretching.

83. The film product of claim 63, wherein said topcoat layer has a thickness of 0.7 to 2.2 microns after stretching.

84. The film product of claim 61, wherein the weight ratio of said polyester to said polyvinyl alcohol in said tie layer is in the range of 90:10 to 10:90.

85. The film product of claim 61, wherein the weight ratio of said polyester to said polyvinyl alcohol in said tie layer is in the range of 80:20 to 20:80.

86. The film product of claim 61, wherein said support film produces a reflective polarizing effect.

87. A tie layer film, comprising an admixture of a sulfonated polyester and PVA formed by blending a quantity of aqueous PVA into a water dispersion of said sulfonated polyester, applying said dispersion on a substrate, and drying said applied dispersion to form a tie layer film on said substrate, said tie layer film bonding a first substrate to a second substrate.

88. In a film system having a PVA layer and a polyester layer, the improvement comprising: a tie layer bonding said PVA layer to said polyester layer, said tie layer comprising an admixture of a sulfonated polyester and PVA.

89. The tie layer of claim 88, wherein said PVA layer is formed from the same PVA as said tie layer.

90. The tie layer of claim 88, wherein said polyester layer is formed from the same sulfonated polyester as said tie layer.
